(19) United States
(12) Patent Application Publication
(10) Pub. No.: US 2012/0110969 A1
(43) Pub. Date: May 10, 2012

(54) Topper For A Cane Harvester

(76) Inventor: Micchael L. Hinds, Thibodaux, LA (US)

(21) Appl. No.: 12/943,317

(22) Filed: Nov. 10, 2010

(51) Int. Cl. A01D 45/10

(52) U.S. Cl. 56/63

(57) ABSTRACT

A topper for a stalk plant harvester for cutting tops from stalk-like plants includes a frame, a pair of cutting blades carried by the frame, and a deflector vane pivotally coupled with the frame. The cutting blades are spaced apart from each other relative to a travel direction, with each cutting blade rotating about a respective generally vertical axis. The deflector vane is selectively movable between a first position for directing cut tops to one side of the topper and a second position for directing cut tops to an opposite side of the topper.

### FIELD OF THE INVENTION

The present invention relates to agricultural harvesters, and, more particularly, to harvesters for the harvesting of stalk-like crops.

### BACKGROUND OF THE INVENTION

Two known types of stalk-like crops in the North American market are sugarcane and sorghum. Other stalk-like or cane-like crops have been receiving increasing attention in bioenergy circles, such as miscanthus, energy cane, and giant reed. During the harvesting of sugarcane, it is known to top the sugarcane plant by cutting off the top portion of the plant using a separate cutter head and allowing the top of the plant to simply fall to the ground.

Sorghum is a major cereal grain that is one of the oldest known crops and is used as a staple food in many parts of Africa and Asia. Sorghum is a major feed grain crop in the US, Mexico, Argentina, Australia, and South Africa. It is believed that sorghum was introduced into the United States in the 1700's and some believe that Benjamin Franklin introduced the first grain sorghum crop. The seed of grain sorghum is the smallest of the major spring-planted field crops, such as corn and soybeans.

Both sugarcane and sorghum are members of the grass family. Sugarcane is native to warm, temperate to tropical regions, the cane having stout, jointed, fibrous stalks that are rich in sugar and measure six to nineteen feet tall. Sugarcane is able to convert up to two percent of the incident solar energy into biomass. Once sugarcane is planted, a stand can be harvested several times. After each harvest, the cane sends up new stalks called rattons. Each successive harvest produces a decreasing yield, eventually leading to a replanting operation.

The harvesting of sugarcane includes the cutting of the cane at the base of the stalk, stripping the leaves, chopping the cane into consistent lengths, and depositing the cane into a transporting device. The harvester typically blows the leaves and such back onto the ground.

Sugarcane harvesting machines utilize a basecutter device that is integral with the main frame of the machine. The height of the cut is regulated by the raising and lowering of the main portion of the machine attached to a mainframe. The adjustment of the cutting height also causes the adjustment in the height of the rest of the machine, including the operator's cab, which can cause discomfort to the operator as the harvester, along with the operator, is moved up and down by frequent adjustments in cutting height. This is particularly a problem on machines that use some sort of automatic basecutter height adjustment.

Sugarcane harvesting machines also utilize a topper that is positioned above and forward of the base cutter. The topper cuts off the top portion of the sugarcane plant. Current designs of toppers use a single high speed rotating cutting device for cutting the tops and either fixed guides or slower rotating devices called collector drums to bring the tops to the cutting device. After initially breaking into the field, it is necessary to be able to direct the unwanted tops either to the right or left of the travel direction. This is so that the ejected tops do not enter the machine when cutting subsequent rows. The tops are thus thrown into a row that has been previously harvested. The normal method of directing the cut tops is to reverse the rotational direction of the cutter device which kicks the top in the direction of rotation.

On totally hydraulic powered harvesters as there are numerous harvesting functions, and usually more than one harvesting function is combined in the hydraulic circuit with the topping device. These additional harvesting functions are also powered by hydraulic motors but in their case, they have a preferred direction of rotation while harvesting. They are only reversed to clear a choke. Thus some form of direction control valve is needed such that the topping device is reversed but not the other functions. The addition of such a valve adds unwanted restriction to the hydraulic fluid, thus consuming power and fuel.

What is needed in the art is a topper for a stalk plant harvester that can more easily and effectively deflect the tops of the plants to the left or right.

### SUMMARY

The invention in one form is directed to a harvester for harvesting stalks of stalk-like plants. The harvester includes a main frame, a basecutter assembly carried by the main frame, and a topper carried by the main frame above the basecutter assembly. The topper includes a pair of cutting blades each rotating about a respective generally vertical axis, and a deflector vane which is selectively movable between a first position for directing cut tops to one side of the topper and a second position for directing cut tops to an opposite side of the topper.

The invention in another form is directed to a topper for a stalk plant harvester for cutting tops from stalk-like plants. The topper includes a frame, a pair of cutting blades carried by the frame, and a deflector vane pivotally coupled with the frame. The cutting blades are spaced apart from each other relative to a travel direction, with each cutting blade rotating about a respective generally vertical axis. The deflector vane is selectively movable between a first position for directing cut tops to one side of the topper and a second position for directing cut tops to an opposite side of the topper.

### BRIEF DESCRIPTION OF THE DRAWINGS

The above-mentioned and other features and advantages of this invention, and the manner of attaining them, will become more apparent and the invention will be better understood by reference to the following description of embodiment of the invention taken in conjunction with the accompanying drawings, wherein:

FIG. 1 is a side view of an embodiment of an agricultural harvester of the present invention for harvesting stalk-like plants;

FIG. 2 is a perspective view of an embodiment of a topper of the present invention, which may be used with the harvester shown in FIG. 1;

FIG. 3 is another perspective view of the topper shown in FIG. 2;

FIG. 4 is a top view of the topper shown in FIGS. 2 and 3; and

FIG. 5 is a side view of the topper shown in FIGS. 2-4.

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION

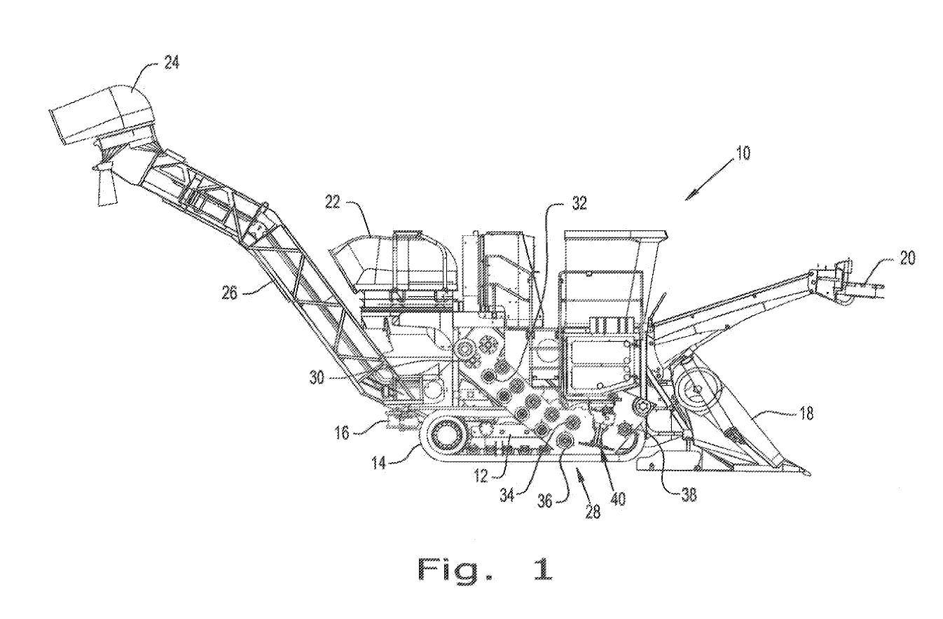

Referring now to the drawings, and more particularly to FIG. 1, there is shown an embodiment of an agricultural work machine in the form of a harvester 10 for the harvesting of stalk-like crops. Harvester 10 includes an undercarriage 12 having a ground contacting propulsion system 14 attached thereto. A main frame 16 is movably connected to undercarriage 12, allowing elevation of most of harvester 10 by the elevating of main frame 16 above undercarriage 12 to a desired position. Harvester 10 additionally includes crop dividers 18, a topper 20, a primary extractor 22, a secondary extractor 24, an elevator 26, and a stalk processing section 28. Topper 20 cuts off the upper portion of the crop, either allowing it to fall on the ground or moving it to another portion of the machine for further processing. Primary extractor 22 blows the lighter weight leafy material from harvester 10. Secondary extractor 24 provides another flow of air to remove lighter weight material from the processed crop stalks. Elevator 26 moves chopped pieces of stalk from the main portion of harvester 10 rearward and toward a stalk holding device, such as a wagon (not shown).

Stalk processing section 28 includes chopper knives 30, feed rollers 32, a specific upper feed roller 34, a butt lift roller 36, a knock down roller 38, and a basecutter assembly 40. As cane moves into harvester 10, knock down roller 38 functions to knock down a portion of the cane before it meets basecutter assembly 40. After the cane is cut, then butt lifter roller 36 lifts up the butt end of the cane so that it can engage upper feed roller 34 and subsequent feed rollers 32. As the cane is moved further into stalk processing section 28 and encounters chopper knives 30 that chop the stalk into substantially uniform lengths and passes the material toward primary extractor 22 as it proceeds to leave harvester 10 for being deposited into the wagon (not shown).

Basecutter assembly 40 cuts the stalks off near the bottom of the stalk-like plants. Basecutter assembly 40 is moveable relative to main frame 16 in a generally vertical direction, thereby allowing the cutting height of the stalks to be adjusted during a harvesting operation.

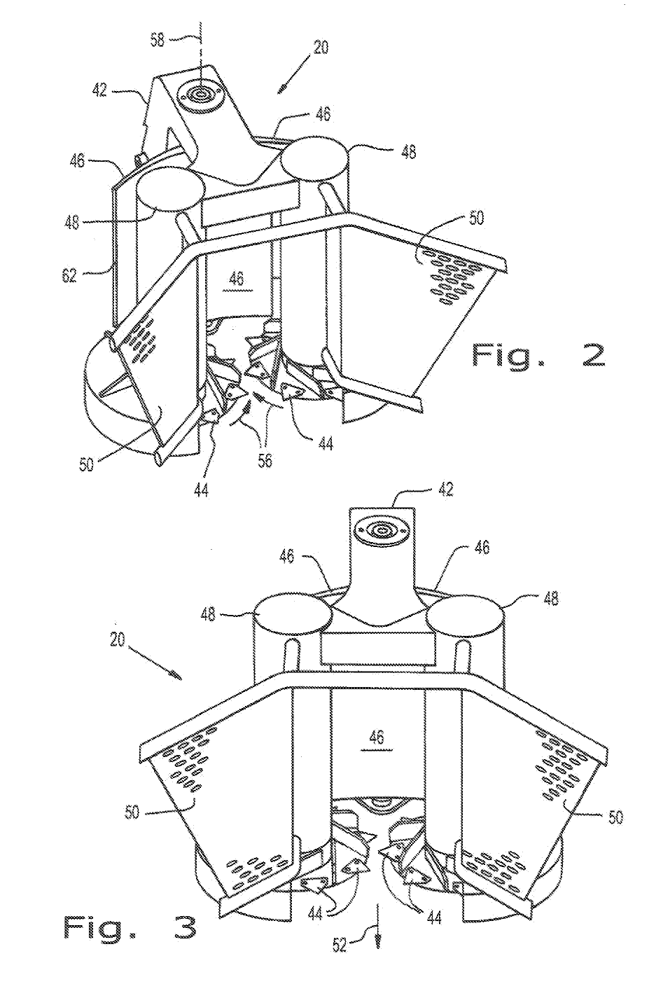

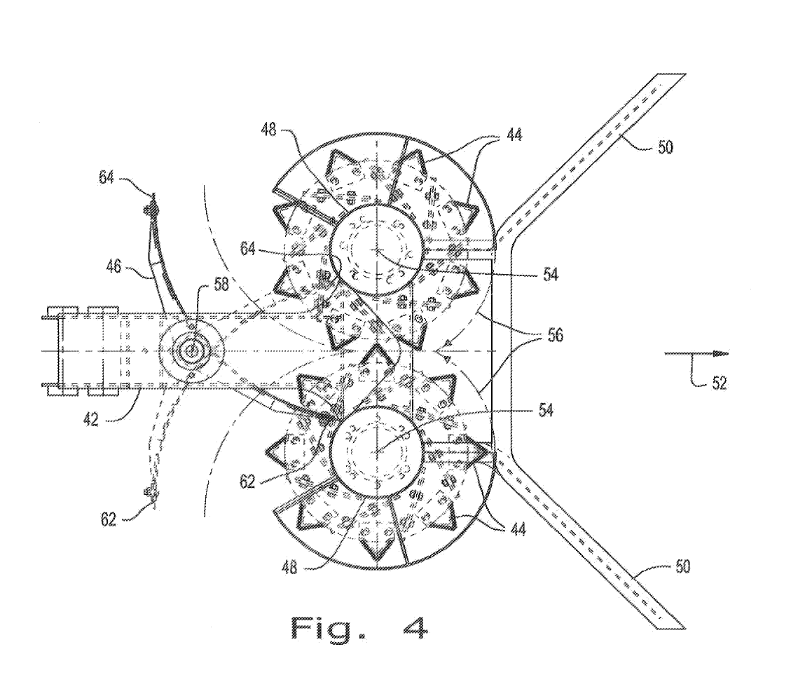

Referring now to FIGS. 2-5, topper 20 is shown in greater detail. Topper 20 generally includes a frame 42, a pair of cutting blades 44, a deflector vane 46, a pair of tubular members 48 and a pair of angled guide surfaces 50.

Frame 42 is generally C-shaped, as can best be seen in FIG. 5. Frame 42 carries the other components making up topper 20, as will be described below in more detail.

Cutting blades 44 are carried by frame 42 and spaced apart from each other relative to a travel direction 52 (i.e., spaced transverse to the travel direction 52). Each cutting blade 44 rotates about a respective generally vertical axis vertical axis 54, with the pair of cutting blades 44 rotating toward each other as indicated by arrows 56.

The pair of tubular members 48 are each positioned above a respective cutting blade 44. A motor (not shown) such as a hydraulic motor is located inside each tubular member 48, and cutting blades 44 are mounted to the bottom of each respective motor. Tubular members 48 are configured as cylindrical tubular members in the illustrated embodiment, with a curved surface adjacent to the travel path of the cut tops allowing the cut tops to freely travel rearwardly through topper 20. The exterior shape of topper 20 need not necessarily be cylindrical but could also be oblong, hexagonal, square, etc. while still allowing the cut tops to travel rearwardly through topper 20.

Angled guide surfaces 50 are positioned forward of the pair of cutting blades 44, relative to travel direction 52, for guiding the tops of the stalk-like plants toward the pair of cutting blades 44. Each angled guide surface 50 is shown as a generally planar surface positioned at a predetermined angle relative to travel direction 52. The particular shape and angular orientation of guide surfaces 50 can vary, depending on the application.

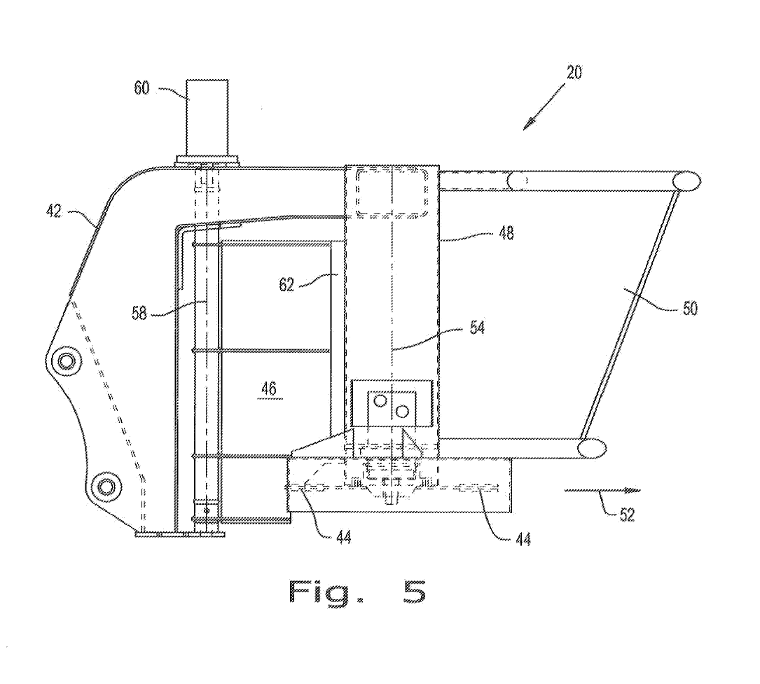

Deflector vane 46 is pivotally coupled with frame 42 about a generally vertical pivot axis 58. Pivot axis 58 is generally centrally located between each of the pair of cutting blades 44. Deflector vane 46 is selectively pivotable using a motor 60 (FIG. 5) which is configured as a hydraulic motor in the illustrated embodiment, but could also be configured as an electric or pneumatic motor. Deflector vane 46 is selectively movable between a first position (shown in solid lines in FIG. 4) for directing cut tops to one side of said topper and a second position (shown in dashed lines in FIG. 4) for directing cut tops to an opposite side of said topper.

More particularly, deflector vane 46 has a curved shape allowing cut tops to be selectively deflected to the left or right of topper 20. The particular shape of deflector vane 46 can vary, depending on the application. For example, deflector vane 46 may have a different curvature or even be substantially flat for some applications. Deflector vane 46 includes a first end 62 which lies closely adjacent to one of the tubular members 48 when deflector vane 46 is in the first position (shown in solid lines in FIG. 4), and a second end 64 which lies closely adjacent to the other of the tubular members 48 when deflector vane 46 is in the second position (shown in dashed lines in FIG. 4).

During operation, either fixed guides (such as guide surfaces 50) or rotating collector drums can be used to direct the tops to cutting blades 44. Cutting blades 44 are powered by hydraulic motors in a closed loop hydraulic circuit. Deflector vane 46 is positioned to the rear of cutting blades 44 and directs the cut tops to either one side or the other of harvester 10. The position of deflector vane 46 is controlled by a motor 60 in the form of a hydraulic cylinder. By rotating deflector vane 46, the cut tops are either directed to the left or right of machine travel with no need of reversing cutting blades 44.

With conventional topper designs, wasted power is consumed by the directional valve used to reverse the cutter blades. Topper 20 of the present invention eliminates this wasted power by using closed center hydraulics to always operate the cutting blades in the same direction, and thus eliminates the need for a control valve. If other harvesting elements are combined in the hydraulic circuit used to drive the cutting blades, they also would be reversed by altering the flow direction. The present invention alters the direction of the ejected tops such that there is no need to reverse the flow to the motor(s) driving the cutting blades.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A harvester for harvesting stalks of stalk-like plants, said harvester comprising:
a main frame;
a basecutter assembly carried by said main frame; and
a topper carried by said main frame above said basecutter assembly, said topper including a pair of cutting blades each rotating about a respective generally vertical axis, and a deflector vane which is selectively movable between a first position for directing cut tops to one side of said topper and a second position for directing cut tops to an opposite side of said topper.

2. The harvester of claim 1, wherein said topper includes a frame, and said deflector vane is pivotally connected to said frame about a generally vertical pivot axis.

3. The harvester of claim 2, wherein said pivot axis is generally centrally located between each of said pair of cutting blades.

4. The harvester of claim 1, wherein said deflector vane has a curved shape.

5. The harvester of claim 1, wherein said topper includes a pair of tubular members, each positioned above a respective said cutting blade.

6. The harvester of claim 5, wherein said deflector vane includes a first end which lies closely adjacent to one of said tubular members when said deflector vane is in said first position, and a second end which lies closely adjacent to an other of said tubular members when said deflector vane is in said second position.

7. The harvester of claim 1, including a hydraulic motor for moving said deflector vane between said first position and said second position.

8. The harvester of claim 1, wherein said pair of cutting blades rotate toward each other.

9. The harvester of claim 1, further including a pair of angled guide surfaces positioned forward of said pair of cutting blades, relative to a travel direction of said harvester, for guiding the tops of the stalk-like plants toward said pair of cutting blades.

10. A topper for a stalk plant harvester for cutting tops from stalk-like plants, said topper comprising:
a frame;
a pair of cutting blades carried by said frame, said cutting blades being spaced apart from each other relative to a travel direction, each said cutting blade rotating about a respective generally vertical axis; and
a deflector vane pivotally coupled with said frame, said deflector vane being selectively movable between a first position for directing cut tops to one side of said topper and a second position for directing cut tops to an opposite side of said topper.

11. The topper of claim 10, wherein said deflector vane is pivotally connected to said frame about a generally vertical pivot axis.

12. The topper of claim 11, wherein said pivot axis is generally centrally located between each of said pair of cutting blades.

13. The topper of claim 10, wherein said deflector vane has a curved shape.

14. The topper of claim 10, wherein said topper includes a pair of tubular members, each positioned above a respective said cutting blade.

15. The topper of claim 14, wherein said deflector vane includes a first end which lies closely adjacent to one of said tubular members when said deflector vane is in said first position, and a second end which lies closely adjacent to an other of said tubular members when said deflector vane is in said second position.

16. The topper of claim 10, including a hydraulic motor for moving said deflector vane between said first position and said second position.

17. The topper of claim 10, wherein said pair of cutting blades rotate toward each other.

18. The topper of claim 10, further including a pair of angled guide surfaces positioned forward of said pair of cutting blades, relative to a travel direction, for guiding the tops of the stalk-like plants toward said pair of cutting blades.
